(19) United States
(12) Patent Application Publication
(10) Pub. No.: US 2013/0290084 A1
(43) Pub. Date: Oct. 31, 2013

(54) SOCIAL NETWORK ADVERTISING

(71) Applicant: Shmuel Ur, Misgav D.N. (IS)

(72) Inventor: Shmuel Ur, Misgav D.N. (IS)

(21) Appl. No.: 13/664,464

(22) Filed: Oct. 31, 2012

Related U.S. Application Data
(60) Provisional application No. 61/639,903, filed on Apr. 28, 2012.

(51) Int. Cl. G06Q 30/02

(52) U.S. Cl. 705/14.16

(57) ABSTRACT

A computer-implemented method, computerized apparatus and computer program product. The method performed by a computerized device. The method comprising: publishing on a social network platform a dynamic promotion, wherein the dynamic promotion is attributed to a user, wherein the dynamic promotion is associated with a merchant; and in response to one or more interactions by other users with the dynamic promotion, calculating a reward for the first user that is redeemable in a transaction with the merchant.

### CROSS-REFERENCE TO RELATED APPLICATION

This application claims the benefit of U.S. Provisional Application No. 61/639,903 filed Apr. 28, 2012, entitled “Method and system for creating, granting and accepting coupons through social networks”, which is hereby incorporated by reference in its entirety.

### TECHNICAL FIELD

The present disclosure relates to advertising using a social network of users.

### BACKGROUND

There is a wide variety of techniques to advertise in a computerized environment. One example of an advertisement technique is to serve an ad that is deemed relevant to an online content and to a reader thereof, thereby exploiting online real-estate in an optimal manner.

A social networking service, also referred to as a social network platform, is an online service, platform, or site that focuses on facilitating the building of social networks or social relations among people who, for example, share interests, activities, backgrounds, or real-life connections. A social network platform may comprise a representation of each user (e.g. a profile) and the social links of the user. Some social network platforms allow users to interact over the Internet or a computer network with each other. Furthermore, a social network platform may allow a user to publish a message to his social network. For example, in Facebook™, a user may update his status or write on a timeline thereby publishing information to users that are in social relationship with the user. Users that have suitable permissions, such as the user's social connections, may interact with the message in a public or private manner.

Public interactions may include, for example, endorsement of the content of the message (e.g., Like™ in Facebook™), republishing the message (e.g., sharing in Facebook™ or retweeting in Tweeter™), and commenting on the message. Other public interactions may also be available, depending on the social network platform.

Other forms of interactions may include interacting with an interactive message, clicking on the message, or the like.

### BRIEF SUMMARY

One exemplary embodiment of the disclosed subject matter is a computer-implemented method performed by a computerized device, comprising: publishing on a social network platform a dynamic promotion, wherein the dynamic promotion is attributed to a user, wherein the dynamic promotion is associated with a merchant; and in response to one or more interactions by other users with the dynamic promotion, calculating a reward for the first user that is redeemable in a transaction with the merchant.

Another exemplary embodiment of the disclosed subject matter is a computerized apparatus having a processor, the processor being adapted to perform the steps of: publishing on a social network platform a dynamic promotion, wherein the dynamic promotion is attributed to a user, wherein the dynamic promotion is associated with a merchant; and in response to one or more interactions by other users with the dynamic promotion, calculating a reward for the first user that is redeemable in a transaction with the merchant.

Yet another exemplary embodiment of the disclosed subject matter is a computer program product comprising a non-transitory computer readable medium retaining program instructions, which instructions when read by a processor, cause the processor to perform a method comprising: publishing on a social network platform a dynamic promotion, wherein the dynamic promotion is attributed to a user, wherein the dynamic promotion is associated with a merchant; and in response to one or more interactions by other users with the dynamic promotion, calculating a reward for the first user that is redeemable in a transaction with the merchant.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a computerized environment in which the disclosed subject matter is used, in accordance with some exemplary embodiments of the subject matter;

FIG. 2A-2C show flowchart diagrams of methods, in accordance with some exemplary embodiments of the disclosed subject matter;

FIG. 3 shows a block diagram of an apparatus, in accordance with some exemplary embodiments of the disclosed subject matter; and

FIG. 4A-4F show illustrations of dynamic promotions, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is to provide a system for incentivizing users to promote a merchant.

Another technical problem is to provide a reward based on a success measurement of the promotion. The reward may be based on metrics which are indicative of how effective the promotion was in reaching relevant audiences.

Yet another technical problem is to provide for a method and system of utilizing effectively a social network of a user in a social network platform.

One technical solution is to allow a user to publish to a social network platform a dynamic promotion. The dynamic promotion is a message which is attributed to the user (e.g., indicated as a post by the user) and which is associated with a merchant. The dynamic promotion may include a message, a text, an image, or the like, that indicate that the user is, was or will be engaging in a transaction with the merchant. The value of the dynamic promotion may be based on the reaction and interaction of other users with the dynamic promotion.

The dynamic promotion may be posted to a social network platform by a profile associated with the user, thereby making it publicly available to the connections of the user in the social network platform. Other users may interact with the dynamic promotion, such as by endorsing the dynamic promotion (e.g., pressing a Like button), by commenting on the dynamic promotion in the social network platform, by publishing the dynamic promotion (e.g., sharing the dynamic promotion), or the like. In some cases, the dynamic promotion itself may be implemented as an interactive widget with which the users may interact. In some exemplary embodiments, the dynamic promotion may include a button allowing users to join the merchant's mailing list, club, or the like.

It will be understood that the promotion is dynamic in the sense that the reward from the promotion to the user is dynamic and its value may change based on the interactions of different users.

In some exemplary embodiments, interactions by users may be monitored by the merchant using a server.

Based on the interactions, a reward to the user may be calculated. The reward may be, for example, based on a mathematical formula which is a function of the number of interacting users, such as for example f (n)=n·2$,

$$f ( n ) = \sum \frac{1}{n} \cdot 2 \$ , \\ f ( n ) = \{ \begin{matrix}0 \$ & n < 5 \\ 10 \$ & 5 \leq n < 10 \\ 12 \$ & 10 \leq n ,\end{matrix}$$

or the like. In some exemplary embodiments, the reward may be for example, geometrical progression. For example, if the value of the first interaction is a 10% discount, the value of every interaction after that could be ½ the previous. In such a scenario the reward is no more than a 20% discount. Additionally or alternatively, an interaction may increase the value of the reward by a portion of the previous interaction, such as 80%. Other schemes, such as an arbitrary scheme in which there may be up to a predetermined number of interactions which are taken into account, such as 20 interactions, and their value is defined in an arbitrary value, such as (4,3,3,3,2,1, . . . 1). In some exemplary embodiments, the value may increase for example the value of the interactions may be: 1, 1, 1, 1, 1.1, 1, 1, 1, 1, 1.1, . . . , or the like. Additionally or alternatively, the total value of the reward may depend on the number of interactions but each interaction is attributed an equal share of the reward. Such a feature may have an impact on a kickback reward to an interacting user which is based on the added-value that the interaction provided, as is further detail hereinbelow.

In some exemplary embodiments, the dynamic promotion may either yield a zero reward or a predetermined reward. As an example, the reward may be a 10% discount if and only if there are at least five interactions.

In some exemplary embodiments, the reward may be a discount in percentile of a transaction. Additionally or alternatively, the discount may be based on a specific transaction and relevant to such transaction. As an example, the dynamic promotion may be associated with purchasing jeans of a specific make and model and the reward may be a discount in purchasing the jeans. Additionally or alternatively, the reward may be provided in products or services instead of a monetary value, such as for example the reward may be a free product or service. Any reward program may be applicable as the reward of the dynamic promotion.

In some exemplary embodiments, different types of interactions may provide different added-value to the dynamic promotion. Additionally or alternatively, different interacting users may be associated with a higher increase in the reward. As an example, users demographic characteristics may be examined and based thereon they may be classified into one of three groups: irrelevant users, relevant users and focal group. An interaction by an irrelevant user may have no effect on the reward. An interaction by a user in the focal group may provide higher return to the user than the same interaction by a user in the relevant users group. The focal group may include, for example, people who already did the transaction in the past.

In some exemplary embodiments, an interaction may generate increase in the reward based on the order of the interaction. For example, the first interaction may provide higher increase than the sixth interaction.

In some exemplary embodiments, a user interacting with the dynamic promotion may receive a reward as well. The reward may be based on the value of the interaction to the user, such that if the increase in the reward to the user is user the reward to the interacting user is also higher. As another example, the first-in-time interacting user may receive a higher reward than the second-in-time interacting user.

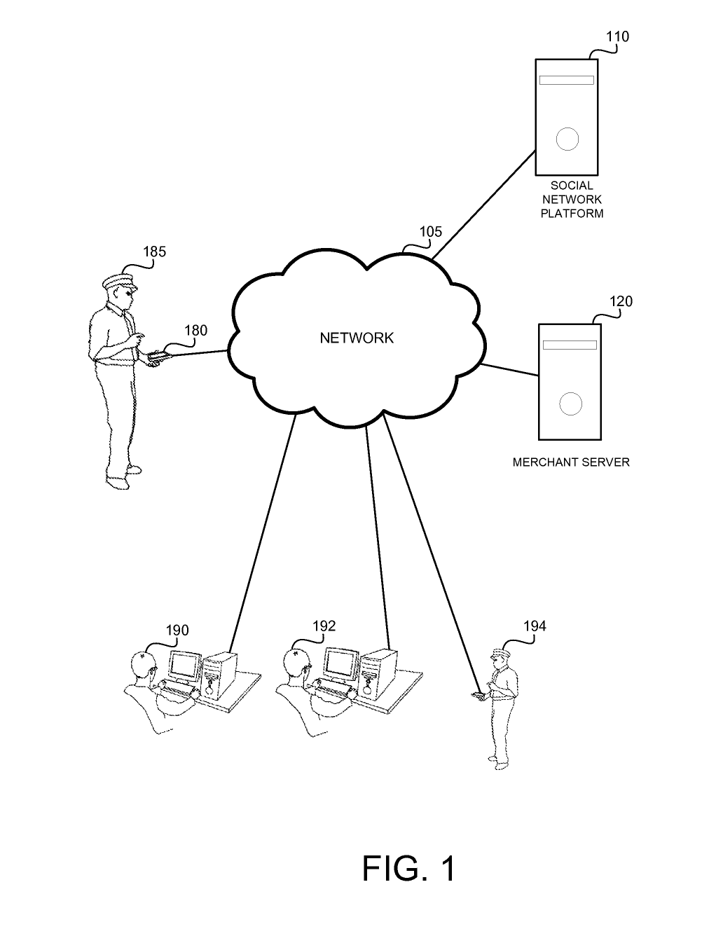

Referring now to FIG. 1 showing a computerized environment in which the disclosed subject matter is used, in accordance with some exemplary embodiments of the subject matter.

A User 185 may utilize a Device 180, such as but not limited to a mobile device, a smart phone, a Personal Digital Assistant (PDA), a laptop computer, a tablet, a desktop computer, or the like, to interact with a Network 105, such as but not limited to the Internet, an intranet, or the like. User 185 may use a Social Network Platform 110, such as Facebook™, LinkedIn™, Google+™, Twitter™, or the like, to connect and communicate with his social network. Other users, such as 190, 192, 194 may use computerized devices, such as Device 180, to connect and communicate with the User 185 via the Social Network Platform 110. It will be understood that the Social Network Platform 110 may be one or more computerized servers providing a social network service to users, such as 185, 190, 192, 194, which may or may not be web-based.

User 185 may publish to Social Network Platform 110 a dynamic promotion that is associated with merchant (not shown). The dynamic promotion may be posted using a Merchant Server 120, which is operated or controlled by the merchant. In one embodiment, the dynamic promotion may be stored in a server (not shown) connectable to Network 105. Additionally or alternatively, an address (e.g., Uniform Resource Locator (URL)) of the dynamic promotion may be retrievable from Merchant Server 120 and may be posted to Social Network Platform 110 using the address.

In some exemplary embodiments, for each user, such as 185, that would like to publish the dynamic promotion, an instance of the dynamic promotion may be generated. In some exemplary embodiments, each instance may have a different address.

Other users connected to User 185 in the Social Network Platform 110, such as 190, 192, 194, may interact with the dynamic promotion, such as by endorsing the dynamic promotion, commenting on it, republishing it, or the like

Merchant Server 120 may monitor, either in real-time or post factum, which users have interacted with the dynamic promotion. Based on the interactions, the interacting users, a reward to User 185 may be computed. In some exemplary embodiments, a kickback reward may be calculated to each interacting user. In some exemplary embodiments, the kickback reward may be bestowed after User 185 redeems his reward.

In some exemplary embodiments, the dynamic promotion may be published via a multiplicity of social network platforms. The reward may or may not be computed based on all interactions with the published dynamic promotion in the multiplicity of social network platforms.

In some exemplary embodiments, the merchant may have a social network profile that is socially connected to the User 185, thereby providing Merchant Server 120 access to information which may not be publicly available, such as identity of interacting users. In some exemplary embodiments, publishing the dynamic promotion may include also connecting in the social network the profile of User 185 with the profile of the merchant.

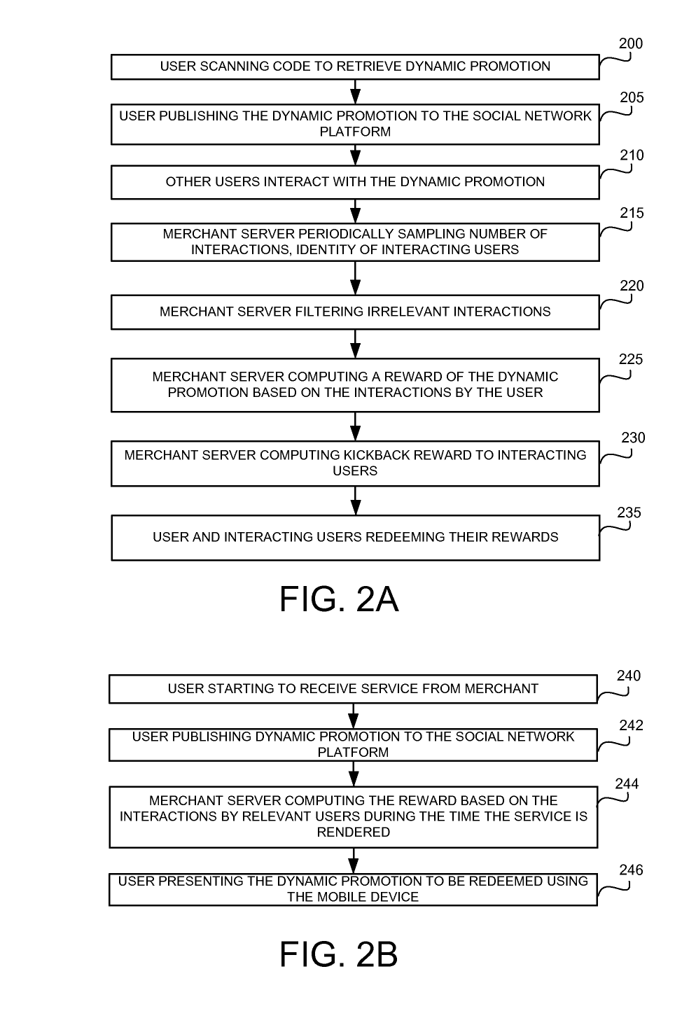

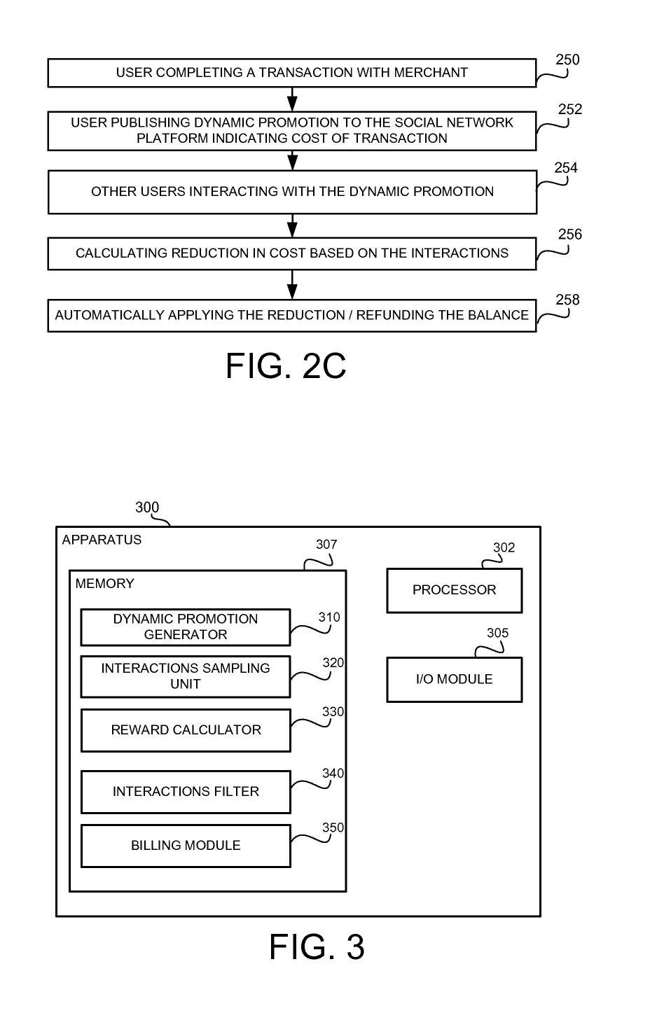

Referring now to FIG. 2A showing a method in accordance with some embodiments of the disclosed subject matter.

In Step 200, a user, such as 185, may scan a code, such as a Quick Response (QR) code, a barcode, or the like using Device 180 to retrieve the dynamic promotion. The dynamic promotion may be retrieved from Network 105. Additionally or alternatively, the user may manually input an identifier, a URL, a serial number, or another unique identifier of the dynamic promotion to retrieve it.

In Step 205, the user may publish the dynamic promotion to a social network platform, such as operated by 110. In some exemplary embodiments, the user may utilize an app in a smart phone for retrieving and publishing the dynamic promotion in a single manual operation.

In Step 210, other users may interact with the dynamic promotion. The other users may be exposed to the dynamic promotion due to their social connectivity to the user.

In Step 215, merchant server, such as 120, may sample number of interactions with the dynamic promotion. In some exemplary embodiments, the server may periodically sample number of interactions. Additionally or alternatively, the server may sample the number of interactions at one or more predetermined timings. Additionally or alternatively, the server may determine identity of interacting users. In some exemplary embodiments, profiles of interacting users may be obtained from the social network platform. In some exemplary embodiments, demographic parameters of the interacting users may be obtained or inferred.

In Step 220, merchant server may filter irrelevant interactions. In some exemplary embodiments, interactions may be irrelevant based on their timing. In some exemplary embodiments, interactions by irrelevant users may be deemed irrelevant. A user may be deemed irrelevant in view of demographic parameters or other characteristics, such as but not limited to geographic location, a socioeconomic profile, age, gender, whether the user is a member of a client-base or not, whether the user has previously interacted with a dynamic promotion of the merchant, whether the user has published the dynamic promotion by the merchant, whether the user registered to receive promotions in the past, whether the user bought things, whether the user lives in a particular location, whether the user participated in a merchant's previous promotion, whether the user did not previously participate in a merchant's previous promotion, whether the user physically visited a merchant location within a timeframe, whether the user registered with the merchant, whether the user completed a transaction with merchant in the past, whether the user got the same or similar product as indicated in the dynamic promotion, the number of users that are socially connected to the profile of the user, or the like. In some exemplary embodiments, the merchant may define relevant and irrelevant users.

In Step 225, the merchant server may compute a reward of the dynamic promotion for the user. The reward may be based on the interactions. The reward may be based on the number of interactions, timing of interactions, characteristics of the interacting users, or the like. In some exemplary embodiments, different users may be considered of additional value to the merchant and accordingly the user may be rewarded with a higher reward for getting them to interact. Such users may be identified based on their characteristics and based on a definition of the merchant of groups of users having different-value.

In Step 230, a kickback reward to each interacting user may be computed by the merchant server. The kickback reward may be calculated based on the added-value gained by the user in view of the interaction. In some exemplary embodiments, the kickback reward may be computed only after the user redeems his reward. In some exemplary embodiments, the kickback reward calculation is based on the ordinal position of the interacting user. As an example, the first-in-time interacting user may receive a higher kickback reward than the second-in-time interacting user, who may receive a higher kickback reward than the third-in-time interacting user, and so forth.

In Step 235, the user and the interacting users may each redeem their respective rewards with the merchant. Redeeming the reward may be performed by presenting the dynamic promotion to the merchant, by performing an e-commerce transaction and linking to the dynamic promotion, by pressing a redeem button on the dynamic promotion, or the like.

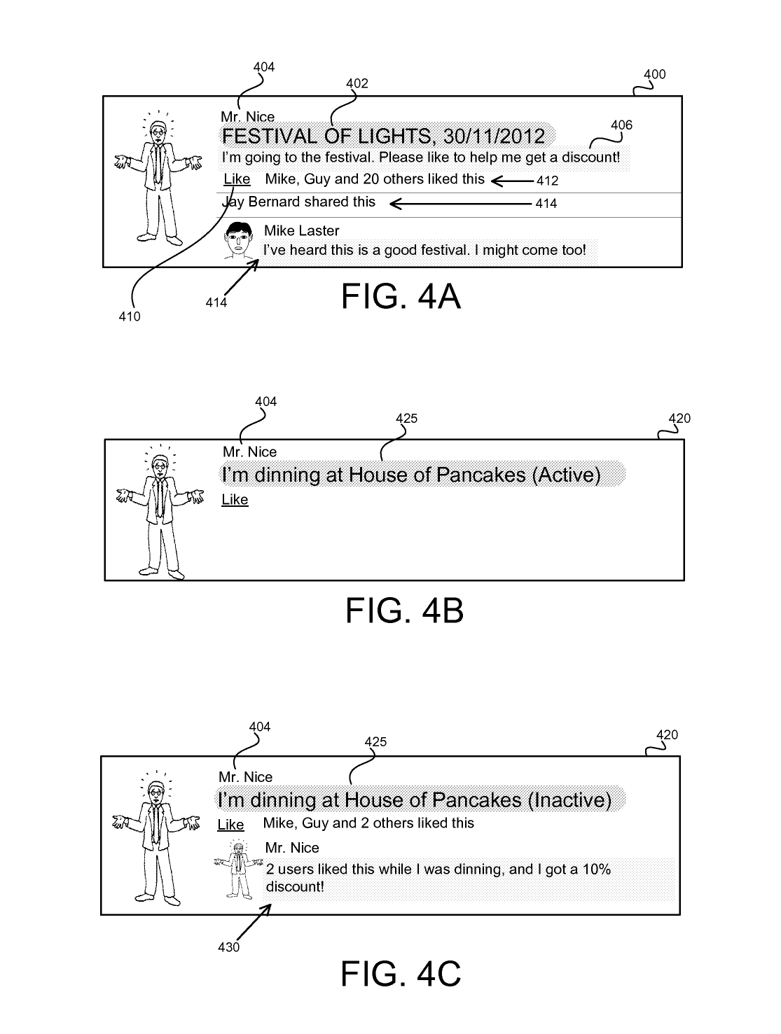

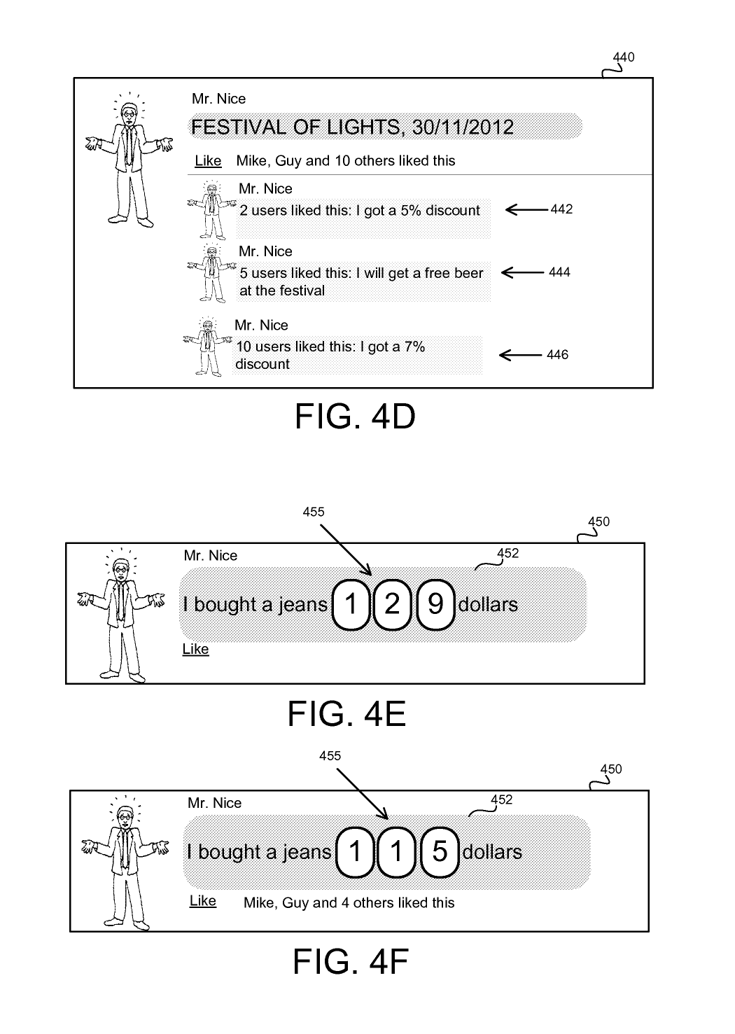

FIG. 4A shows a Dynamic Promotion 400, in accordance with some exemplary embodiments of the disclosed subject matter. Dynamic Promotion 400 is attributed to Mr. Nice (404) and is viewed as a posting by Mr. Nice. An avatar of Mr. Nice is also used to indicate that the Dynamic Promotion 400 is attributed to Mr. Nice.

Dynamic Promotion 400 comprises a Message 402 being promoted. Message 402 may indicate a service, a merchant, or the like. Message 402 may further indicate the promotion and solicit other users to interact with Dynamic Promotion 400. The user may also provide a Personalized Message 406 along with Message 402.

Interactions by other users may include endorsements, which are illustrated as pressing Like Button 410. Users which have endorsed the Dynamic Promotion 400 may be indicated (412). Interactions may also include republishing the Dynamic Promotion 400, which may also be indicated (414). In some embodiments, commenting by a user also be deemed as interacting with the Dynamic Promotion 400, such as Comment 414 by a user having a profile named “Mike Laster”.

It will be understood that in some embodiments, the merchant may define whether an endorsement is considered an interaction, whether republishing is considered an interaction and whether commenting is considered an interaction.

It will be noted that the interactions are publicly indicated and therefore the merchant server may monitor interactions. In some embodiments, the interactions are publicly indicated without indicating the identities of the interacting users. In some cases, the user may have access permission enabling the user to view the identities of the interacting users. Additionally or alternatively, direct social links of the user may have access permission enabling them to view the identities as well. Therefore, the monitoring by the merchant server may be performed using the credentials of the user or credentials of a direct social link of the user. In some cases, in order to provide the merchant with access to said information, the user may add a profile of the merchant as a direct social link in the social network platform.

Referring now to FIG. 2B showing a method in accordance with some embodiments of the disclosed subject matter.

In Step 240, the user starting to receive a service from merchant, such as but not limited to sitting down in a restaurant, attending a concert, beginning a spa treatment, or the like.

In Step 242, the user may publish the dynamic promotion to the social network platform. The dynamic promotion may indicate that the service has commenced and optionally may indicate end time of the service or estimation thereof.

In Step 244, merchant server computes the reward based on the interactions by relevant users during the time the service was rendered. Step 244 may be performed when a bill is issued, when the service is completed, or the like. As an example, at the end of the concert, the merchant server may begin performing step 244 with respect to each user that published the dynamic promotion during the concert.

In Step 246, the user may redeem the reward. It will be understood that the user may use a mobile device to publish the dynamic promotion and/or to redeem the reward, therefore allowing the user to benefit from the dynamic promotion at the merchant location and without prior preparations.

In some exemplary embodiments, the user may publish the dynamic promotion in Step 242 before the service has begun. The dynamic promotion may be associated with the service and interactions performed before the service commenced may be deemed irrelevant, or provide different (higher/lower) value to the user than interactions performed while the service is rendered.

FIG. 4B-4C show a Dynamic Promotion 420 useful in the method of FIG. 2B. Dynamic Promotion 420 is attributed to the user (404). Dynamic Promotion 420 comprises a Message 425 indicating that the user is receiving a service. In some cases, an explicit indication that the Dynamic Promotion 420 is active may be provided, such as using text, color, shape, or any visual or other cue. One example of such indication is shown in FIG. 4B.

When the promotion is no longer active, such as after a predetermined time window is closed, after the service is completed, or the like, an inactive indication may be provided, as is exemplified in FIG. 4C.

In some exemplary embodiments, a manual or automatic message, such as Comment 430, may be published indicating the reward. The message (e.g., Comment 430) may also be used to thank the interacting users.

As can be seen, in Comment 430 it is shown that the reward is because of 2 interacting users, while there 4 interacting users (“Mike, Guy and 2 others liked this”). This may be because out of the 4 interacting users, 2 interacting users may have been filtered out in view of them being deemed irrelevant. As an example, only the users which are located near the restaurant (“House of Pancakes”) may be deemed relevant.

Referring now to FIG. 4D showing a Dynamic Promotion 440, in accordance with some embodiments of the disclosed subject matter. A reward of Dynamic Promotion 440 is selected from a predetermined set of possible rewards, based on the number of interacting users. After reaching a first level, such as 2 interacting users, a first reward is provided. After reaching a second level, such as 5 interacting users, a second reward is provided. After reaching a third level, such as 10 interacting users, may be provided.

It will be noted that the different rewards may be cumulative or non-cumulative. For example, Dynamic Promotion 440 may include a reward of 7% discount and a free beer. In some cases, if the reward is of the same type (a discount), the new level may indicate that total reward (e.g., first level provides 5% discount, the third level provides an additional 2% , and therefore a total of 7% discount).

After reaching each level, a message, such as Comments 442, 444, 446, that the reward is provided to the user may be generated automatically. In some cases, Comments 442, 444, 446 may be posted by a profile of the merchant after the merchant server has monitored Dynamic Promotion 440 and determined that the next level was reached.

It will be noted that the rewards of different levels may be of different nature, such as, for example, a free product (beer) and a discount.

Referring now to FIG. 2C showing a method in accordance with some embodiments of the disclosed subject matter.

In Step 250, the user may complete a transaction with the merchant.

In Step 252, the user may publish a dynamic promotion to the social network platform. The dynamic promotion may be linked or otherwise associated to the transaction, such as using a unique transaction identifier. The dynamic promotion may indicate the details of the transaction, such as the nature of the transaction, the cost of the transaction, or the like.

In Step 254, other users may interact with the dynamic promotion.

In Step 256, a reward in the form of a reduction in cost of the transaction may be computed based on the interactions.

In Step 258, the reduction may be automatically applied. In some cases, the reduction may be applied before the transaction is cleared (e.g., before the payment is performed via a payment system such as a credit card). Alternatively, the reduction may be applied as a rebate or refund in the order of the user even after the transaction is cleared.

Dynamic promotions associated with a method such as of FIG. 2C are depicted in FIGS. 4E-4F. In FIG. 4E, a Dynamic Promotion 450 is shown. The dynamic promotion comprises a Message 452 in which the details of the transaction are provided. In some cases, the merchant's name may also appear in Message 452. A cost of the transaction may be indicated in Widget 455. In response to interactions with the Dynamic Promotion 450 (e.g., “like” by 6 users), a reward is calculated and Widget 455 may indicate updated (and reduced) cost of the transaction, as can be seen in FIG. 4F. In some cases, Widget 455 may be updated in response to each interaction by an interacting user therefore indicating to each interacting user the value derived by the user thanks to the interacting user's interaction. Alternatively, Widget 455 may be updated periodically or upon closing of a timeframe in which interactions are deemed relevant, such as, for example, two hours after the transaction is performed.

Referring now to FIG. 3 showing an Apparatus 300 in accordance with some exemplary embodiments of the disclosed subject matter. Apparatus 300, such as 120 of FIG. 1, may be configured to assist in publishing dynamic promotions and determine the rewards to the users.

In some exemplary embodiments, Apparatus 300 may comprise a Processor 302. Processor 302 may be a Central Processing Unit (CPU), a microprocessor, an electronic circuit, an Integrated Circuit (IC) or the like. Processor 302 may be utilized to perform computations required by the apparatus 300 or any of it subcomponents.

In some exemplary embodiments of the disclosed subject matter, Apparatus 300 may comprise an Input/Output (I/O) Module 305. I/O Module 305 may be utilized to provide an interface to a user, such as an administrator, to configure Apparatus 300, such as by defining relevant and irrelevant users and interactions, defining dynamic promotions as availability thereof, defining automated responses, and monitoring characteristics or the like. I/O Module 305 may be used to allow Apparatus 300 to connect to other computerized devices, such as via Network 105.

In some exemplary embodiments, Apparatus 300 may comprise a Memory 307. Memory 307 may be persistent or volatile. For example, Memory 307 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, Memory 307 may retain program code operative to cause Processor 302 to perform acts associated with any of the steps shown in FIGS. 2A-2C.

The components detailed below may be implemented as one or more sets of interrelated computer instructions, executed for example by Processor 302 or by another processor. The components may be arranged as one or more executable files, dynamic libraries, static libraries, methods, functions, services, or the like, programmed in any programming language and under any computing environment.

A Dynamic Promotion Generator 310 may be configured to generate a dynamic promotion. Dynamic Promotion Generator 310 may be configured to generate a promotion having a unique identifier. The promotion may be associated with a merchant and optionally with a specific transaction/offer by the merchant. The promotion may be published to a social network platform of a user using credentials of the user, such as by posting a URL address of the dynamic promotion to a timeline of the user. Dynamic Promotion Generator 310 may be responsive to a command from the user, such as a command requesting issuance of a dynamic promotion and providing credentials to act in the name of the user in the social network platform.

An Interactions Sampling Unit 320 may be configured to monitor interactions by other users with each generated dynamic promotion. Sampling may be performed periodically, at predetermined timings, in response to a predetermined event, or the like. The sampling may be performed by accessing the social network platform to view the published dynamic promotion and retrieve indications of interactions therewith by interacting users. The access may be performed using the credentials of the user. Alternatively or additionally, the access may be performed using the credentials of the merchant, wherein the merchant may be a direct social link of the user and therefore may have access to the information published by the user and to the identities of the interacting users.

Interactions Filter 340 may be configured to filter-out irrelevant interactions. An interaction may be deemed irrelevant based on the identity of the interacting user, based on the content of the interaction, based on the interaction type, or the like. For example, positive comment may be deemed as an interactive while a negative comment may be deemed as irrelevant. Using Natural Language Processing (NLP) methods, the negative and positive comments may be distinguished from one another. Additionally or alternatively, interactions by automated users, spammers, fake profiles, or the like may be deemed irrelevant users. As another example, an endorsement interaction may be considered relevant while a comment interaction may be considered irrelevant.

It will be understood that any parameter or characteristic that may be used for defining an interaction as irrelevant may be used to define different value to interactions, and vice versa. In some cases, users may be grouped into value groups, such as the users whose interactions would not affect the reward are grouped as the irrelevant users group, and the other users are grouped into group, each associated with a different added-value.

Reward Calculator 330 may be configured to calculate a reward for the user who published the dynamic promotion. Additionally or alternatively, Reward Calculator 330 may calculate a kickback reward to interacting users. In some cases, Reward Calculator 330 may calculate the reward based only on interactions that are not filtered by Interaction Filter 340. In some exemplary embodiments, Reward Calculator 330 may be configured to compute the kickback reward in response to the user redeeming his reward, the user completing a transaction which is the subject of the dynamic promotion or is otherwise referred to in the dynamic promotion, or the like.

Billing Module 350 may provide billing and/or payment capabilities to Apparatus 300. In some embodiments, Billing Module 350 may provide an interface to a dedicated billing server (not shown). Billing Module 350 may enable determining whether a transaction has been completed, whether a reward was redeemed, updating a cashier system with the reward/kickback reward so that it may be redeemed by the user/interacting user, or the like.

### Additional Details

The disclosed subject matter provides several features. One feature is the ability of friends to increase the reward to a user, preferably through social network platforms. Another feature is that in order to get a big reward, the user may desire that many friends will interact and thereby provide a substantial reward. The social network platform may be used to publish the dynamic promotion, to interact with promotions and thereby increase their value, learn which of a user's friends can provide additional reward, search product promotions, register to a merchant, publish the result of the promotion ,or the like.

In some exemplary embodiments, the disclosed subject matter may incentivize users to have their connections and other users interact with the promotion. The disclosed subject matter may also incentivize to fast reaction if the kickback reward that the interacting user receives depends on the timing or ordinal position of the interaction or similar parameters.

In some exemplary embodiments, an interacting user may be seen as issuing a coupon to the user, and the reward is a cumulative value of the coupons.

In some exemplary embodiments, the merchant can designate different groups that can issue coupons, such as for example one who registers with the merchant, one who actually paid for something, one who got the same product, the merchant himself, someone in the vicinity, and the like. In some exemplary embodiments, a user may issue more than one coupon (e.g., one coupon per different interaction). In some cases, users of different group may issue a different number of coupons (or different types of coupons) depending on their status. In some exemplary embodiments, the merchant may allow other people to add people who can give coupons in a pyramid like scheme.

In some exemplary embodiments, a coupon is personal and associated with the product, product category, or store when it can be redeemed. The coupon may also be associated with both the issuer and the issue of the coupon. The coupon generation is preferably electronic and when a coupon is issued its ordinal number may be known (i.e. third coupon for the product) and therefore the value.

In some exemplary embodiments, a mobile device may be configured to automatically publish a dynamic promotion and optionally notify a user's connection of the user's interest in receiving coupons using the dynamic promotion. The mobile device may identify the location of the user and upon determining that the location is associated with a specific dynamic promotion, publish the dynamic promotion. In some exemplary embodiments, the mobile device may enable publishing the dynamic promotion only from predefined locations. In some exemplary embodiments, the location of the interacting user may be determined and interacting will be enabled only in case the interacting user is in specific locations. Additionally or alternatively, the mobile device may scan a barcode, such as a barcode of a product to be purchased, and determine that a relevant dynamic promotion exists.

In some exemplary embodiments, the user may use a mobile device to scan a product to determine if there is a relevant dynamic promotion.

### Sample Scenarios

In one embodiment, a user may enter a store and identify a desired pair of jeans, the cost of which is 200$. A 40% discount may be available via a dynamic promotion. The user may become aware to the existence of the dynamic promotion when scanning the barcode of the jeans using a mobile device having a designated app installed thereon. The user may publish the dynamic promotion and optionally receive an initial reward of, for example 10%, for publishing the dynamic promotion. The reward may be increased if the dynamic promotion is accompanied by a user-generated input, such as a personalized comment, a picture of the product, or the like. In some cases, an additional reward may be provided for adding a picture out of a collection of one or more predetermined pictures. The user may solicit users of his social network to interact with the dynamic promotion in order to increase his reward. Additionally or alternatively, users may interact with the dynamic promotion without the user's solicitation. The user may or may not indicate a timeframe in which the interactions would be relevant, such as indicate that the user intends to purchase the jeans in 30 minutes. The reward may be automatically redeemed as the mobile device may communicate to the server of the merchant that the user is in the store and performing a trans action.

In another embodiment, a user may perform online shopping in an online store. While adding items to a shopping cart, or when checking out, the user may press a designated button at the web page of the online store in order to publish a dynamic promotion which is relevant to the content of his shopping cart. In some embodiments, and in order to retain privacy, the dynamic promotion may be published to a limited number of users, such as via email, using a restricted publication, the social network platform, or the like. Additionally or alternatively, the privacy may be retained by not disclosing the items in the user's shopping cart.

The dynamic promotion, which may comprise the content of the shopping cart. may be active for a predetermined amount of time, such as two days. During this time window, users may interact to issue coupons and bestow a reward in the form of a discount. In some embodiments, users of a “Gold” status in the online store may bestow higher reward than those with a lesser status or no status at all. The process may be stopped beforehand by the user when completing a transaction. Additionally or alternatively, the user may complete the transaction and the reward may be redeemed automatically later on, such as by reducing the amount when charging the user's credit card or by refunding the amount to the user's account.

In some exemplary embodiments, the disclosed subject matter enables interaction by an interacting user using a single user-action, such as one click. Additionally or alternatively, publishing the dynamic promotion may be performed using a single user-action.

In some exemplary embodiments, the dynamic promotion may be published so that it is visible only to relevant users, such that any user that is deemed irrelevant, such as based on its location or demographic characteristics, may not view or access the dynamic promotion. In some exemplary embodiments, a mobile application may be installed on each user's mobile device. The mobile application may determine whether the user is a relevant user with respect to a dynamic promotion that was published by a social connection of the user, and based on the determination decide whether or not to display the dynamic promotion to the user. In some exemplary embodiments, the mobile application may transmit the information to a server which may determine whether or not to transmit the information regarding the dynamic promotion to the mobile device based on the relevancy of the campaign. It will be noted that relevancy may change over time, such as for example based on the location of the user (e.g., the location of the mobile device).

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method performed by a computerized device, comprising:
publishing on a social network platform a dynamic promotion, wherein the dynamic promotion is attributed to a user, wherein the dynamic promotion is associated with a merchant; and
in response to one or more interactions by other users with the dynamic promotion, calculating a reward for the first user that is redeemable in a transaction with the merchant.

2. The computer-implemented method of claim 1, wherein the one or more interactions with the dynamic promotion are publicly visible to at least the user and the merchant.

3. The computer-implemented method of claim 1, wherein the one or more interactions with the dynamic promotion are interactions via the social network platform which are publicly accessible to a social network of an interacting user.

4. The computer-implemented method of claim 3, wherein the interactions are selected from a group consisting of: sharing the dynamic promotion, expressing support in the dynamic promotion, and commenting on the dynamic promotion.

5. The computer-implemented method of claim 1, wherein the dynamic promotion is published on the social network platform and is attributed, in the social network platform, to the user, and wherein the dynamic promotion is publicly accessible to a social network of the user.

6. The computer-implemented method of claim 1, wherein the dynamic promotion is updated in response to the one or more interactions to indicate the reward.

7. The computer-implemented method of claim 1, wherein in response to the transaction being completed, publishing on the social network platform an indication that the reward was redeemed in the transaction.

8. The computer-implemented method of claim 1, wherein the dynamic promotion is visible only to relevant users.

9. The computer-implemented method of claim 1, wherein irrelevant interactions are ignored and are not taken into account in said calculating.

10. The computer-implemented method of claim 9, wherein irrelevant interactions are interactions by irrelevant users, wherein the merchant defines characteristics of the irrelevant users.

11. The computer-implemented method of claim 10, wherein the irrelevant users are determined based on their respective locations.

12. The computer-implemented method of claim 9, wherein the irrelevant interactions are interactions performed outside a predefined time range.

13. The computer-implemented method of claim 12, wherein the dynamic promotion comprises a message indicating that the user is receiving a service from the merchant, and wherein the predefined time range is a time during which the service is being rendered.

14. The computer-implemented method of claim 1, wherein the dynamic promotion comprises a message indicating that the user purchased a product or received a service from the merchant, and wherein the reward is a portion of a cost of the product or service that is discounted.

15. The computer-implemented method of claim 1, wherein the reward is a discount for the user that is redeemable in a transaction with the merchant.

16. The computer-implemented method of claim 1, wherein the reward is provided to the user instead of another user, based on having a larger number of interactions with the soliciting message that is attributed to the user than a number of interactions with another soliciting message that is attributed to the another user.

17. The computer-implemented method of claim 1, wherein said calculating is characterized in increasing the reward for each additional user interacting with the dynamic promotion by a decreasing value.

18. The computer-implemented method of claim 1, wherein said calculating is characterized in increasing the reward for each additional user interacting with a different value.

19. The computer-implemented method of claim 1, wherein the other users comprise a first user and a second user, and wherein a first and a second reward that are provided to the first and second users respectively, are based on an increment in the reward to the user that is attributed to the first and second users respectively.

20. The computer-implemented method of claim 1, wherein said publishing the dynamic promotion based on a command from the user using a mobile device, and wherein the reward is redeemable from the merchant by the user by presenting an indication of the reward using the mobile device.

21. A computerized apparatus having a processor, the processor being adapted to perform the steps of:
publishing on a social network platform a dynamic promotion, wherein the dynamic promotion is attributed to a user, wherein the dynamic promotion is associated with a merchant; and
in response to one or more interactions by other users with the dynamic promotion, calculating a reward for the first user that is redeemable in a transaction with the merchant.

22. A computer program product comprising a non-transitory computer readable medium retaining program instructions, which instructions when read by a processor, cause the processor to perform a method comprising:
publishing on a social network platform a dynamic promotion, wherein the dynamic promotion is attributed to a user, wherein the dynamic promotion is associated with a merchant; and
in response to one or more interactions by other users with the dynamic promotion, calculating a reward for the first user that is redeemable in a transaction with the merchant.
